(19) United States
(12) Patent Application Publication
(10) Pub. No.: US 2025/0329064 A1
(43) Pub. Date: Oct. 23, 2025

(54) INFORMATION PROCESSING DEVICE, TERMINAL DEVICE, AND MAAS PROVIDING METHOD

(71) Applicant: TOYOTA JIDOSHA KABUSHIKI KAISHA, Toyota-shi (JP)

(72) Inventor: Kazuo OKINO, Tokyo (JP)

(73) Assignee: TOYOTA JIDOSHA KABUSHIKI KAISHA, Toyota-shi (JP)

(21) Appl. No.: 19/021,770

(22) Filed: Jan. 15, 2025

(30) Foreign Application Priority Data
Apr. 19, 2024 (JP) 2024-068669

(51) Int. Cl. G06T 11/00

(52) U.S. Cl. CPC G06T 11/00

(57) ABSTRACT

The information processing device includes a control unit that acquires history information of a user, generates persona information in which the user is classified based on the acquired history information, and causes the terminal device of the user to display persona information in addition to the information related to the persona information.

### CROSS-REFERENCE TO RELATED APPLICATION

This application claims priority to Japanese Patent Application No. 2024-068669 filed on Apr. 19, 2024, incorporated herein by reference in its entirety.

### BACKGROUND

### 1. Technical Field

The present disclosure relates to an information processing device, a terminal device, and a MaaS providing method.

### 2. Description of Related Art

Conventionally, there has been known technology for classifying a user into a persona such as attribute, category, and so forth, based on information such as an activity history and so forth of the user, and proposing information that better matches needs of the user to the user. For example, Japanese Patent No. 7194132 discloses a feature extraction device that enables exhaustive analysis of a supply chain without omission, taking into consideration consumer activities of consumers, without human comprehension of business features.

### SUMMARY

The user cannot readily know which persona he/she has classified into as a result of information being classified into personas in this way. As a result, sufficient sense of satisfaction of users with information related to persona information displayed on a terminal device has not been obtained.

An object of the present disclosure that has been made in light of the foregoing circumstances is to improve a sense of satisfaction of the user with respect to information that is related to persona information displayed on a terminal device.

An information processing device according to an embodiment of the present disclosure includes
a control unit that acquires history information of a user, generates persona information that classifies the user based on the history information that is acquired, and causes a terminal device of the user to display the persona information in addition to information related to the persona information.

A terminal device according to an embodiment of the present disclosure includes a control unit that acquires persona information, obtained by classifying a user based on history information of the user, from an information processing device, and displays the persona information in addition to information related to the persona information that is acquired.

A Mobility as a Service (MaaS) providing method according to an aspect of the present disclosure provides MaaS that uses the above information processing device.

According to an embodiment of the present disclosure, the sense of satisfaction of the user with the information related to the persona information displayed on the terminal device is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram illustrating an example of a configuration of an information processing system including an information processing device according to an embodiment of the present disclosure;

FIG. 2 is a block diagram illustrating an example of a configuration of the information processing device of FIG. 1;

FIG. 3 is a block diagram illustrating an example of a configuration of the terminal device of FIG. 1;

FIG. 4 is a sequence diagram for explaining a first example of an information processing method executed by the information processing system of FIG. 1;

FIG. 5 is a flowchart for explaining a second example of the information processing method executed by the information processing system of FIG. 1; and

FIG. 6 is a schematic diagram for explaining an example of an operation of the information processing system of FIG. 1.

### DETAILED DESCRIPTION OF EMBODIMENTS

Hereinafter, an embodiment of the present disclosure will be described with reference to the accompanying drawings. The following description also applies to the information processing system 1 including the information processing device 10 and the terminal device 20 to which the present disclosure is applied.

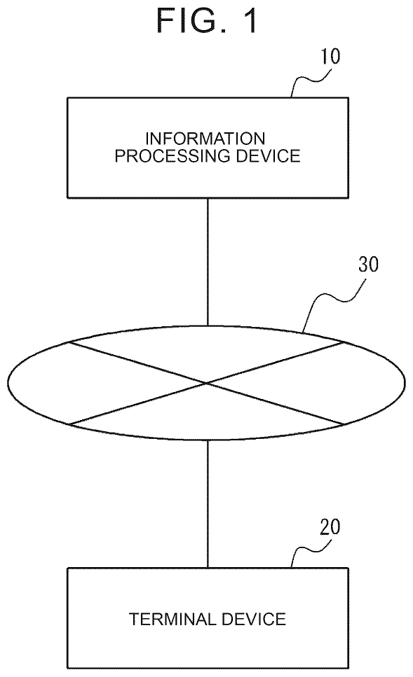

FIG. 1 is a configuration diagram illustrating an example of a configuration of an information processing system 1 including an information processing device 10 according to an embodiment of the present disclosure. An outline of the information processing system 1 including the information processing device 10 according to the embodiment of the present disclosure will be mainly described with reference to FIG. 1. The information processing system 1 includes a terminal device 20 in addition to the information processing device 10.

Although only one information processing device 10 is illustrated in FIG. 1 for convenience of explanation, the number of information processing devices 10 included in the information processing system 1 may be two or more. Similarly, although only one terminal device 20 is illustrated in FIG. 1, the number of terminal devices 20 included in the information processing system 1 may be two or more. Each of the information processing device 10 and the terminal device 20 is communicably connected to a network 30 including a mobile communication network, the Internet, and the like. That is, one of the information processing device 10 and the terminal device 20 is communicably connected to another apparatus via the network 30.

The information processing device 10 is, for example, one or a plurality of server apparatuses capable of communicating with each other. The information processing device 10 is not limited thereto, and may be a general-purpose electronic device including a wearable device such as a PC, a tablet PC, a smart phone, or a smart watch, or may be another electronic device dedicated to the information processing system 1. “PC” is an abbreviation for Personal Computer.

The terminal device 20 is a general-purpose electronic device including, for example, a wearable device such as a PC, a tablet PC, a smart phone, or a smart watch. The terminal device 20 is an electronic device used by a user who uses an application using a persona provided by the information processing system 1. The terminal device 20 is not limited thereto, and may be one or a plurality of server devices that can communicate with each other used by the user, or may be another electronic device dedicated to the information processing system 1.

As an overview of an embodiment, the information processing device 10 acquires history information of a user. The information processing device 10 generates persona information that classifies the user based on the acquired history information. The information processing device 10 causes the terminal device 20 of the user to display the persona information in addition to the information related to the persona information.

In the present disclosure, the “history information” includes, for example, an action history and a purchase history in the real world, and a purchase history and a browsing history on-line. The “persona information” includes, for example, information such as a persona that categorizes a user's portrait. The persona information may be image information or other types of information such as text information and voice information. The “information related to persona information” includes, for example, recommendation information for a user classified as a persona, advertisement information suitable for the persona, and the like.

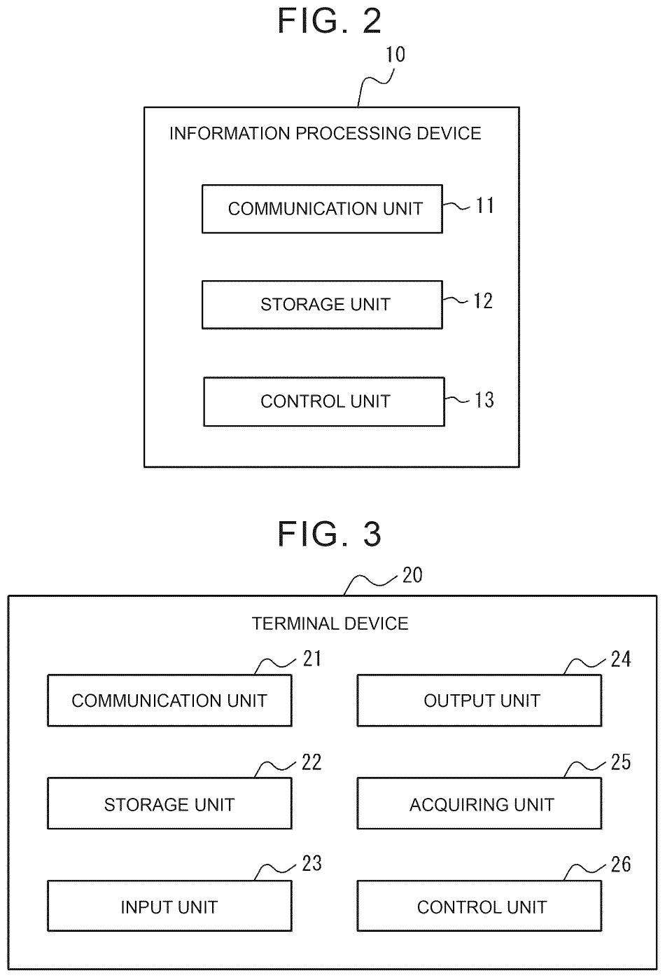

FIG. 2 is a block diagram illustrating an example of a configuration of the information processing device 10 illustrated in FIG. 1. An example of the configuration of the information processing device 10 will be mainly described with reference to FIG. 2. The information processing device 10 includes a communication unit 11, a storage unit 12, and a control unit 13.

The communication unit 11 includes one or more communication interfaces connected to the network 30. The communication interfaces correspond to, for example, a mobile communication standard such as 4G and 5G, a wired LAN standard, or a wireless LAN standard, but are not limited thereto, and may correspond to any communication standard. For example, the communication interface may also correspond to a short-range wireless communication standard. “4G” is an abbreviation for 4th Generation. “5G” is an abbreviation for 5th Generation. “LAN” is an abbreviation for Local Area Network. In one embodiment, the information processing device 10 is communicably connected to the network 30 via the communication unit 11. The communication unit 11 transmits and receives various types of information via the network 30.

The storage unit 12 includes one or more memories. In the present disclosure, the “memory” is, for example, a semiconductor memory, a magnetic memory, an optical memory, or the like, but is not limited thereto. Each memory included in the storage unit 12 may function as, for example, a main storage device, an auxiliary storage device, or a cache memory. The storage unit 12 stores information obtained by the operation of the information processing device 10. The storage unit 12 stores information necessary for realizing the operation of the information processing device 10. For example, the storage unit 12 may store a system program, an application program, embedded software, and the like. The information stored in the storage unit 12 may be updatable with information received from the network 30 via the communication unit 11, for example.

The control unit 13 may include one or more processors, one or more programmable circuits, one or more dedicated circuits, or a combination thereof. A “processor” as used herein is, for example, but not limited to, a general-purpose processor, such as a CPU or GPU, or a special-purpose processor specialized for a particular process. The “programmable circuitry” is, for example, but not limited to, a FPGA. The “dedicated circuitry” is, for example, but not limited to, an ASIC. “CPU” is an abbreviation for Central Processing Unit. “GPU” is an abbreviation for Graphics Processing Unit. “FPGA” is an abbreviation for Field-Programmable Gate Array. “ASIC” is an abbreviation for Application Specific Integrated Circuit. The control unit 13 is connected to each of the components constituting the information processing device 10 so as to be able to communicate with each other and controls the operation of the entire information processing device 10.

FIG. 3 is a block diagram illustrating an example of a configuration of the terminal device 20 of FIG. 1. An example of the configuration of the terminal device 20 will be mainly described with reference to FIG. 3. The terminal device 20 includes a communication unit 21, a storage unit 22, an input unit 23, an output unit 24, an acquiring unit 25, and a control unit 26.

The communication unit 21 includes one or more communication interfaces connected to the network 30. The communication interfaces correspond to, for example, a mobile communication standard such as 4G and 5G, a wired LAN standard, or a wireless LAN standard, but are not limited thereto, and may correspond to any communication standard. For example, the communication interface may also correspond to a short-range wireless communication standard. In one embodiment, the terminal device 20 is communicably connected to the network 30 via the communication unit 21. The communication unit 21 transmits and receives various types of information via the network 30.

The storage unit 22 includes one or more memories. Each memory included in the storage unit 22 may function as, for example, a main storage device, an auxiliary storage device, or a cache memory. The storage unit 22 stores information obtained by the operation of the terminal device 20. The storage unit 22 stores information necessary for realizing the operation of the terminal device 20. For example, the storage unit 22 may store a system program, an application program, embedded software, and the like. The information stored in the storage unit 22 may be updatable with information received from the network 30 via the communication unit 21, for example.

The input unit 23 includes one or more input devices that detect a user input and acquire input information based on an operation of the user. The input device includes a physical key, a capacitive key, a pointing device such as a mouse, a touch screen integrally provided with a display of the output unit 24, an imaging module such as a camera, and a microphone that receives an audio input. The input unit 23 is not limited thereto, and may include any other input device.

The output unit 24 includes one or more output devices that output and notify information to a user who uses the terminal device 20. The output device includes a display that visually outputs information in an image, a speaker that audibly outputs information in a sound, and a vibrator that vibrates and tactilely outputs information. As used herein, “display” includes, for example, LCD and organic EL displays. “LCD” is an abbreviation for Liquid Crystal Display. “EL” is an abbreviation for Electro Luminescent.

The acquiring unit 25 includes one or more receivers corresponding to any satellite positioning system. The receiver includes, for example, a GNSS receiver, such as a GPS receiver. “GPS” is an abbreviation for Global Positioning System. “GNSS” is an abbreviation for Global Navigation Satellite System. The acquiring unit 25 acquires the measured value of the position of the terminal device 20 as the position information. The location information includes, for example, latitude, longitude, altitude, and address. The acquiring unit 25 may always acquire the position information of the terminal device 20, or may acquire the position information periodically or non-periodically.

The control unit 26 includes one or more processors, one or more programmable circuits, one or more dedicated circuits, or a combination thereof. The control unit 26 is communicably connected to the constituent units constituting the terminal device 20, and controls the overall operation of the terminal device 20.

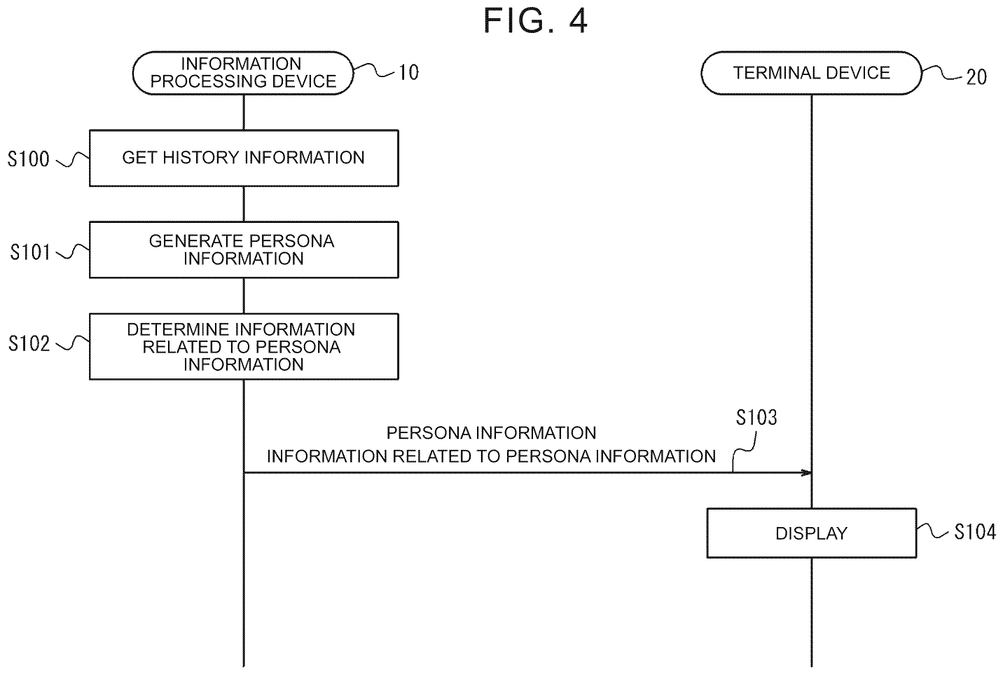

FIG. 4 is a sequence diagram for explaining a first example of an information processing method executed by the information processing system 1 of FIG. 1. With reference to FIG. 4, an operation of the information processing device 10 according to an embodiment will be mainly described, and an overall operation of the information processing system 1 will be outlined. The sequence diagram of FIG. 4 illustrates a flow of basic processing executed by the information processing device 10.

In S100, the control unit 13 of the information processing device 10 acquires the history information of the user. For example, the control unit 13 may acquire the position information based on GPS of the acquiring unit 25 of the terminal device 20 used by the user from the terminal device 20 via the network 30, and acquire the action history of the user in the real-world based on the position information. For example, the control unit 13 acquires the payment information of the user from at least one of the terminal device 20 and the external server included in the payment system via the network 30. The control unit 13 may acquire, based on the settlement information, a purchase history of the user in the real world, an online purchase history, and the like. For example, the control unit 13 may acquire the access history of Web page by the terminal device 20 used by the user from the terminal device 20 via the network 30, and acquire the browsing history of the user online based on the access history.

In S101, the control unit 13 of the information processing device 10 generates persona information in which the user is classified based on the history information acquired in S100. For example, the control unit 13 generates persona information as image information. The control unit 13 may acquire and analyze the history information in S100 at predetermined time intervals, and generate persona information at predetermined time intervals.

In S102, the control unit 13 of the information processing device 10 determines information related to the persona information to the user of the terminal device 20 based on the persona information generated in S101.

In S103, the control unit 13 of the information processing device 10 provides the terminal device 20 with the persona information generated in S101 and the information related to the persona information determined in S102 via the communication unit 11 and the network 30. Thus, the control unit 26 of the terminal device 20 acquires the persona information and the information related to the persona information obtained in the information processing device 10 from the information processing device 10 via the network 30 and the communication unit 21.

In S104, the control unit 26 of the terminal device 20 causes the output unit 24 to display the persona information acquired in S103 and the information related to the persona information. That is, the control unit 26 of the terminal device 20 acquires the persona information that classifies the user based on the history information of the user from the information processing device 10, and causes the output unit 24 to display the persona information in addition to the information related to the acquired persona information. Thus, the control unit 13 of the information processing device 10 causes the terminal device 20 of the user to display the persona information in addition to the information related to the persona information.

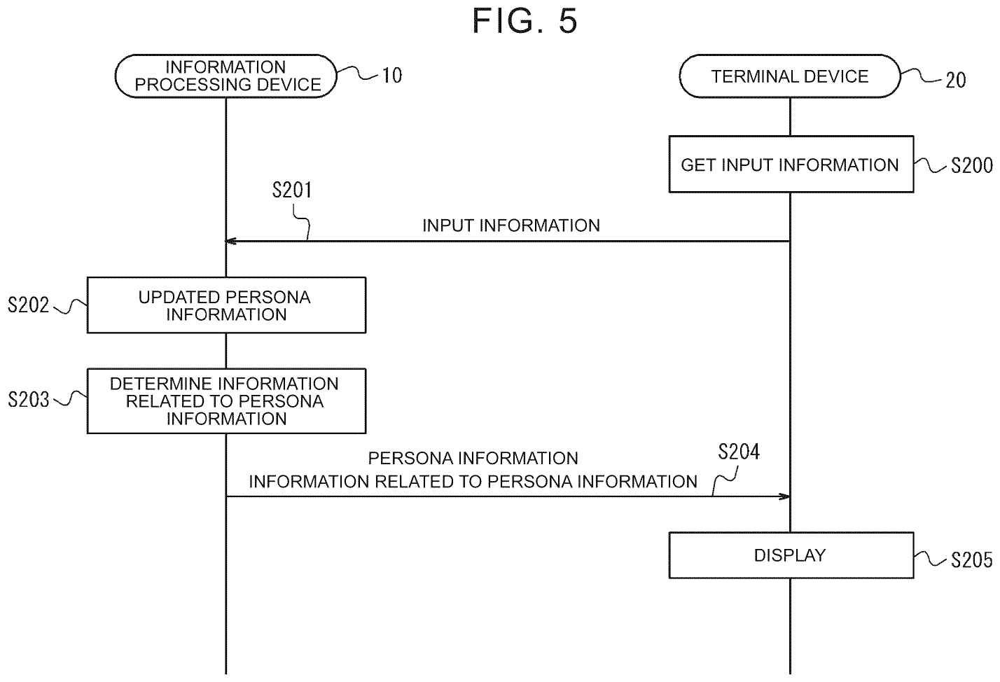

FIG. 5 is a sequence diagram for explaining a second example of an information processing method executed by the information processing system 1 of FIG. 1. With reference to FIG. 5, an operation of the information processing device 10 according to an embodiment will be mainly described, and an overall operation of the information processing system 1 will be outlined. The sequence diagram of FIG. 5 is an example of a flow of a process of updating persona information executed by the information processing device 10.

In S200, the control unit 26 of the terminal device 20 acquires the input data based on the user's input manipulation using the input unit 23. For example, the control unit 26 acquires, by the input unit 23, input information for changing the persona information of the user displayed on the output unit 24 of the terminal device 20.

In S201, the control unit 26 of the terminal device 20 provides the input information acquired in S200 to the information processing device 10. For example, the control unit 26 transmits the input information acquired in S200 to the information processing device 10 via the communication unit 21 and the network 30. Thus, the control unit 13 of the information processing device 10 acquires the input information acquired by the terminal device 20 in S200 from the terminal device 20. For example, the control unit 13 receives input information acquired by the terminal device 20 in S200 from the terminal device 20 via the network 30 and the communication unit 11.

In S202, the control unit 13 of the information processing device 10 updates the persona information based on the input information obtained by the user in S201.

In S203, the control unit 13 of the information processing device 10 determines information related to the persona information to the user of the terminal device 20 based on the persona information updated in S202.

In S204, the control unit 13 of the information processing device 10 provides the terminal device 20 with the persona information updated in S202 and the information related to the persona information determined in S203 via the communication unit 11 and the network 30. Thus, the control unit 26 of the terminal device 20 acquires the persona information and the information related to the persona information obtained in the information processing device 10 from the information processing device 10 via the network 30 and the communication unit 21.

In S205, the control unit 26 of the terminal device 20 causes the output unit 24 to display the persona information acquired in S204 and the information related to the persona information. For example, the control unit 26 of the terminal device 20 acquires the persona information selected by the user from the information processing device 10 using the input unit 23, and causes the output unit 24 to display the persona information in addition to the information related to the acquired persona information. Thus, the control unit 13 of the information processing device 10 causes the terminal device 20 of the user to display the persona information in addition to the information related to the persona information.

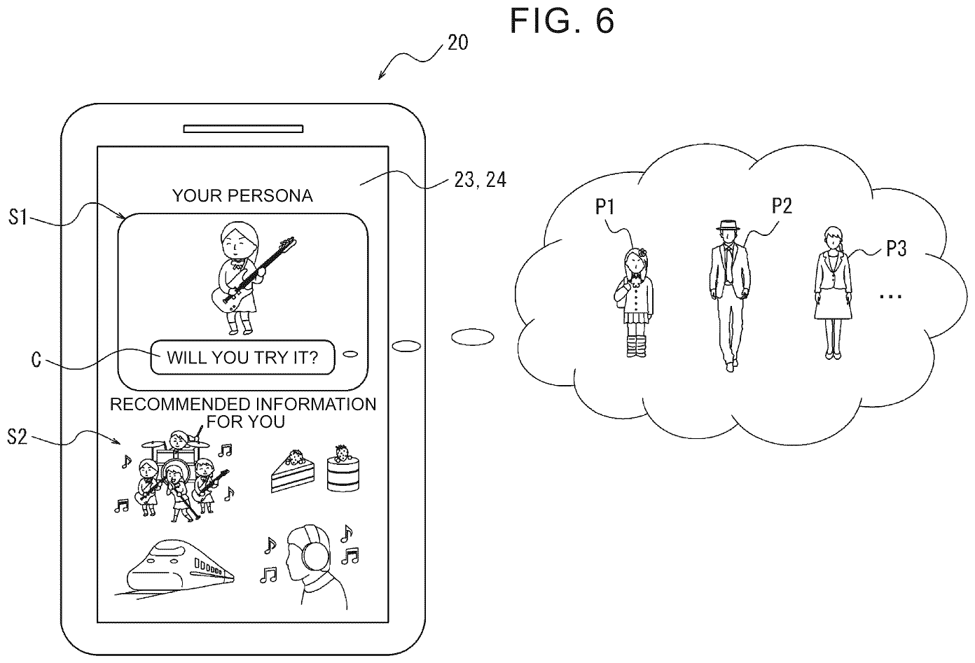

FIG. 6 is a schematic diagram for explaining an example of the operation of the information processing system 1 of FIG. 1. FIG. 6 shows an example of a state in which the terminal device 20 displays both the persona information and the information related to the persona information acquired from the information processing device 10 using the output unit 24 of the terminal device 20. For example, the control unit 26 of the terminal device 20 divides the screen displayed on the output unit 24 into two sections.

The control unit 26 causes the first section SI to display persona information classified by the user of the terminal device 20 as picture information. For example, the control unit 26 causes the persona of the user of the terminal device 20 to be displayed on the first-section S1 as picture data. The control unit 26 displays the persona information generated by the information processing device 10 based on the history information of the user or the persona information updated by the information processing device 10 based on the input information from the user on the first-section S1.

The control unit 26 causes the second-section S2 to display, as picture information, information related to persona information classified by the user of the terminal device 20. For example, the control unit 26 causes the user of the terminal device 20 to display recommended information as image information on the second-section S2. The control unit 26 causes the second section S2 to display recommendations corresponding to the persona displayed on the first section S1. When the persona information displayed in the first section S1 is updated, the control unit 26 instantaneously updates the information related to the persona information displayed in the second section S2. The control unit 26 may be configured to be capable of scrolling the display in the second-section S2, and may control the output unit 24 so that the user can view all of the information related to the persona information provided to the user of the terminal device 20.

In order to enable the input unit 23 to perform an input operation for the user to change the persona displayed in the first section SI to a desired persona, the control unit 26 may further display a predetermined icon C as a user interface on the screen of the output unit 24. For example, the control unit 26 “Try over?” When the user performs a tap operation on the icon C to which text such as text is attached, at least one other persona candidate may be further displayed on the screen of the output unit 24.

For example, when the input unit 23 receives an input operation for the user to select a desired persona from among a plurality of personas including the first persona PI, the second persona P2, and the third persona P3, the control unit 26 may cooperate with the information processing device 10 to update the persona displayed on the first section SI to the selected persona. At this time, the control unit 26 may execute the update process in cooperation with the information processing device 10 so that the user using the terminal device 20 can change the persona in all items of gender, age, hobby, and preference.

According to the information processing device 10 according to the embodiment as described above, the user can easily recognize which persona the user has classified into, and as a result, the information displayed on the output unit 24 of the terminal device 20 is selected. Therefore, the user's satisfaction with the information related to the persona information displayed on the output unit 24 of the terminal device 20 is improved.

Since the analysis result of the information processing device 10 with respect to the history information of the user is displayed as an image on the output unit 24 of the terminal device 20, the user can understand the analysis result at a glance. For example, when the persona information is displayed on the output unit 24 as a persona image that is far from the appearance of the user himself/herself, the user's sense of enhancement is improved. For example, when a high school girl is classified into an image of an uncle's persona or vice versa, a user can obtain a non-routine world view.

The user can know how his or her history information was analyzed at predetermined intervals. A user who periodically confirms information via an application or the like of the terminal device 20 can periodically confirm the updated persona information and enjoy new persona information at predetermined intervals. In addition, for a user who does not frequently view information in the terminal device 20, it is possible to stimulate interest in the persona information and information related to the persona information by periodically updating the persona information, and to prompt the user to confirm the periodic information using the terminal device 20.

The user can freely change the persona desired by himself/herself based on an input operation using the input unit 23 of the terminal device 20. Thus, a user may intentionally select a persona that is far from his or her attributes. As a result, the user can enjoy information of a different world view from that of daily life. For example, it is possible to intentionally select a persona of a young person when an elderly user wants to confirm information for the young person.

The information processing device 10 selects persona information obtained by categorizing a person image of the user on the basis of the history information of the user, and displays the selected persona information itself on the terminal device 20 of the user. The present disclosure is different from the related art in that preference information is generated from an action pattern of a user, and preference information is modified by an individual user. The present disclosure is not intended to optimize the information displayed on the terminal device 20 for each user according to the preference of the user. The present disclosure rather aims to provide a non-routine feeling by intentionally enabling information that is different from the user's own original appearance via persona information. The above-described process of updating the persona information by the information processing device 10 does not relate to the correction of the preference information, but only to the correction of the persona.

Although the present disclosure has been described above based on the drawings and the embodiment, it should be noted that those skilled in the art can make various modifications and alterations thereto based on the present disclosure. It should be noted, therefore, that these modifications and alterations are within the scope of the present disclosure. For example, the functions, etc. included in the configurations, steps, or the like can be rearranged so as not to be logically inconsistent, and a plurality of configurations, steps, or the like can be combined into one or divided.

For example, a general-purpose electronic device such as a smartphone or a computer can be configured to function as the information processing device 10 according to the above-described embodiment. Specifically, a program describing processing contents for realizing each function of the information processing device 10 according to an embodiment is stored in a memory of an electronic device, and the program is read and executed by a processor of the electronic device. Accordingly, the present disclosure can also be implemented as a program that can be executed by a processor.

Alternatively, the present disclosure may also be implemented as a non-transitory computer-readable medium storing a program executable by one or more processors to cause the information processing device 10 and the like according to an embodiment to execute each function. It should be understood that the above configurations are also included in the scope of the present disclosure.

For example, at least a part of the processing operations executed in the information processing device 10 in the above-described embodiment may be executed in the terminal device 20. At least some of the processes that are executed in the terminal device 20 may be executed in the information processing device 10.

In the above embodiment, the information processing system 1 has been described as including the information processing device 10 and the terminal device 20, but the present disclosure is not limited thereto. The information processing system 1 may further include a vehicle used by the user of the terminal device 20. At this time, the control unit 13 of the information processing device 10 may acquire the position information based on GPS of the vehicle used by the user from the vehicle via the network 30, and acquire the action history of the user in the real-world based on the position information. The information processing system 1 may further include a server included in the payment system. At this time, the control unit 13 of the information processing device 10 may acquire the payment information of the user from the server via the network 30, and may acquire the purchase history of the user in the real world, the purchase history on the online, and the like based on the payment information.

In the above embodiment, the control unit 13 of the information processing device 10 acquires and analyzes the history information at predetermined time intervals, and generates persona information at predetermined time intervals, but the present disclosure is not limited thereto. The control unit 13 may generate the persona information on an irregular basis or may generate the persona information only once, without generating the persona information at predetermined time intervals.

In the above-described embodiment, the control unit 13 of the information processing device 10 updates the persona information based on the input information by the user, but the present disclosure is not limited thereto. The control unit 13 may not execute such an update process.

In the above-described embodiment, the information processing device 10 may store a model or the like corresponding to the attribute of the user as information in the storage unit 12, and may accurately generate persona information for classifying the user by determining whether or not the history information matches the model by the control unit 13.

In the above-described embodiment, the information processing device 10 may be used to provide Mobility as a Service (MaaS) that is a service utilizing mobility. The above-described process steps described in the sequential diagrams illustrated in FIGS. 4 and 5 may be executed when providing a service (MaaS) using the information processing device 10. In this case, the information processing method according to the above processing procedure is an exemplary providing method of a service (MaaS) using the information processing device 10.

What is claimed is:

1. An information processing device, comprising:
a control unit that acquires history information of a user, generates persona information that classifies the user based on the history information that is acquired, and causes a terminal device of the user to display the persona information in addition to information related to the persona information.

2. The information processing device according to claim 1, wherein the control unit generates the persona information as image information.

3. The information processing device according to claim 1, wherein the control unit acquires and analyzes the history information at predetermined time intervals, and generates the persona information at the predetermined time intervals.

4. The information processing device according to claim 1, wherein the control unit updates the persona information based on input information from the user.

5. A terminal device comprising:
a control unit that acquires persona information, obtained by classifying a user based on history information of the user, from an information processing device, and displays the persona information in addition to information related to the persona information that is acquired.

6. A Mobility as a Service (MaaS) providing method that uses the information processing device according to claim 1.
